(19) United States
(12) Patent Application Publication
(10) Pub. No.: US 2007/0289012 A1
(43) Pub. Date: Dec. 13, 2007

(54) Remotely controllable security system

(75) Inventor: Leemon Baird, Colorado Springs, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Leemon Baird

(21) Appl. No.: 11/451,936

(22) Filed: Jun. 13, 2006

(51) Int. Cl. G06F 12/14; H04L 9/00; G06F 17/30; H04L 9/32; G06F 12/00; H04K 1/00; G06F 13/00; G06F 7/04; G06F 7/58; G06K 19/00; G11C 7/00

(52) U.S. Cl. 726/17; 726/18; 726/19; 713/183

(57) ABSTRACT

A remotely controllable security system has a number of physical security devices, such as electronic door locks, closed circuit TV cameras, motion detector, etc. Control and monitoring software running on a server is coupled to each of the physical security devices and monitors and stores events. In addition, streaming data can be saved and viewed from cameras and other devices. A mobile computing device is capable of communicating with the server or directly over a wireless channel to the physical security devices. The mobile computing device can view streaming data from the cameras.

### RELATED APPLICATIONS

None

### FIELD OF THE INVENTION

The present invention relates generally to the field of security systems and more particularly to a remotely controllable security system.

### BACKGROUND OF THE INVENTION

A number security systems have been proposed for residences. These systems commonly have a number of sensors to detect intrusion or a fire and alert a central alarm monitoring station. At the central alarm monitoring station operator decides whether to immediately call the authorities, contact the owners or contact the owners' emergency contact. These systems are not well suited for businesses, since they commonly only monitor several set alarm conditions. In addition, the response times are limited since the operators at the central alarm monitoring station are not normally familiar with your business or residence. There are more complex security systems that have multiple cameras that have to be monitored by security personnel. These security personnel are expensive to hire and it is difficult for anyone to constantly monitor multiple monitors.

Thus, there exists a need for a security system that does not require expensive security personnel or a central alarm monitoring station.

### SUMMARY OF INVENTION

A remotely controllable security system that overcomes these and other problems has a number of physical security devices, such as electronic door locks, closed circuit TV cameras, motion detectors, etc. Control and monitoring software running on a server is coupled to each of the physical security devices and monitors and stores events. In addition, streaming data can be saved and viewed from cameras and other devices. A mobile computing device is capable of communicating with the server or directly over a wireless channel to the physical security devices. The mobile computing device can view streaming data from the cameras. The mobile computing device has a cryptographic key for communicating with the server or with the physical security devices. When an alarm condition occurs, the mobile computing device is alerted and the user is present with a list of responses. The responses can include multiple actions, such as call the police and lock down all the doors. Because of the flexibility provided by the mobile computing device a central monitoring station or full time security personnel watching TV monitors is not required.

### BRIEF DESCRIPTION OF THE DRAWINGS

FIG. 1 is a block diagram of a remotely controllable security system in accordance with one embodiment of the invention;

FIG. 2 is a block diagram of a remotely controllable security system in accordance with one embodiment of the invention;

FIG. 3 is a graphical depiction of the physical security devices in accordance with one embodiment of the invention;

FIG. 4 is a block diagram of the software running on a server in accordance with one embodiment of the invention; and

FIG. 5 is a block diagram of the software running on a mobile computing device in accordance with one embodiment of the invention.

### DETAILED DESCRIPTION OF THE DRAWINGS

The invention is a remotely controllable security system that does not require a central alarm monitoring station and does not require expensive security personnel to watch camera monitors. The system has three main components: a number of physical security devices, a control and monitoring software running on a server and a mobile computing device. The physical security devices and the mobile computing device are capable of communicating over a wireless channel. In one embodiment, the physical security devices are electrically connected to wireless access points and can receive communications from the mobile computing device directly without going through the server.

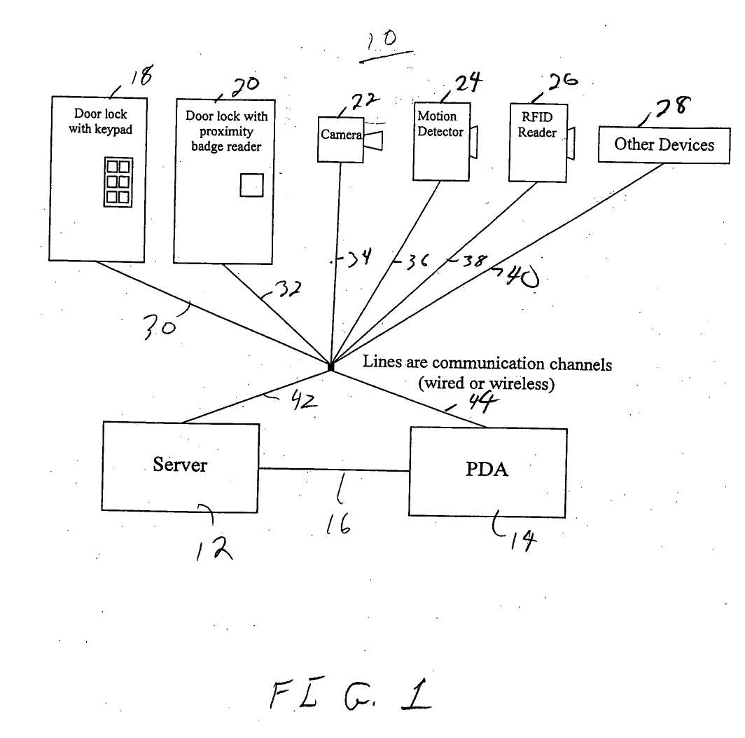

FIG. 1 is a block diagram of a remotely controllable security system 10 in accordance with one embodiment of the invention. The system 10 includes a server 12 that runs a control and monitoring software. A personal digital assistant (PDA) 14 has a communication channel 16 to the server 12. A plurality of physical security devices 18, 20, 22, 24, 26, 28 are in communication with the server 12 and may also communicate directly with the PDA 14. The physical security devices include a controllable door lock and keypad 18, a door lock with proximity badge reader 20, a camera 22, a motion detector 24, a RFID (radio frequency identification) reader 26 and other devices 28. The physical security devices can communicated over communication channels 30, 32, 34, 36, 38, 40, 42, 44 to the server 12 or the PDA 14. The communication channels can be wired, wireless or both. The other devices 28 may include condition detectors, such as those detecting when a window is opened or broken. The monitoring and control software monitors all the physical security devices and keeps a record of all events related to each of the physical security devices. This includes recording video from the camera(s) 22. The monitoring and control software also controls these devices by sending a list of valid codes to the door lock keypad 18. The software also adds and removes authorized users from lists stored in the proximity badge reader 20, RFID readers 26, barcode reader, etc. The control software can cause the cameras to move, zoom and turn on or off. The control software may also lock down doors by refusing to open any doors until further notice. The server many also provide a user interface through the web that allows users to view and control all the devices. The mobile computing device may be a PDA, smart phone, laptop, etc. The mobile computing device runs a web browser which can be used to control the server or special client software can be used to control the server. The server can be used to setup connections between the mobile computing device and the physical computing devices, including streaming video from the camera to the mobile computing device.

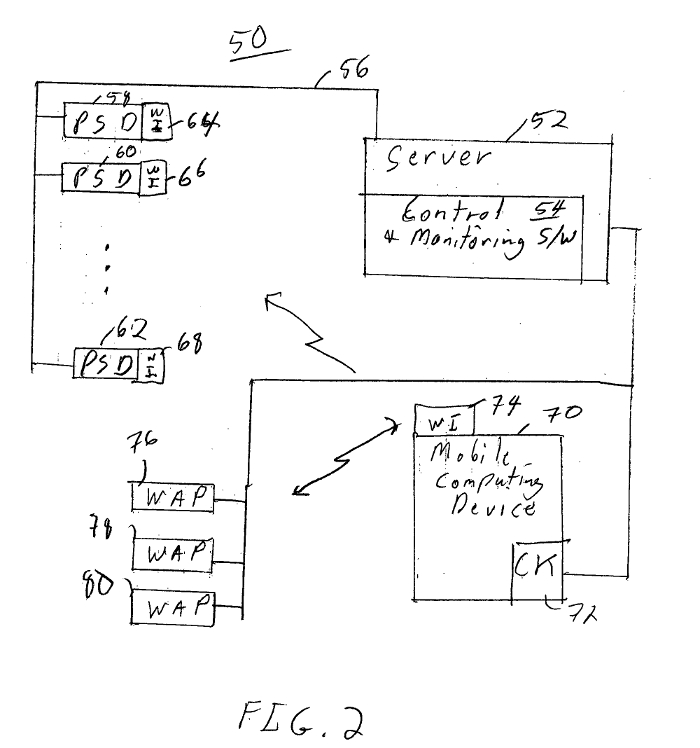

FIG. 2 is a block diagram of a remotely controllable security system 50 in accordance with one embodiment of the invention. The system 50 has a server 52 that runs a control and monitoring software 54. The server 52 has a communication channel 56 to a plurality of physical security devices (PSD) 58, 60, 62. The physical security devices 58, 60, 62 each have a wireless interface (WI) 64, 66, 68 in one embodiment. The server 52 also has a communication channel to a mobile computing device 70. The mobile computing device has a cryptographic key 72, which is necessary to communicate with the server 52. The server 52 will also have a cryptographic key for secure communication. The mobile computing device 70 includes a wireless interface (WI) 74. The WI 74 allows the mobile computing device to communicate directly with the PSDs 58, 60, 62 or to communicate through the a plurality of wireless access points (WAP) 76, 78, 80. The wireless access points 76, 78, 80 are hard wired to the server 52 although it is possible that they could communicate wirelessly with the server 52. The WAPs 76, 78, 80 are also hard wired to the PSDs 58, 60, 62 either directly or through the server 52.

Normally, the mobile computing device 70 communicates with the server 52, which communicates with the PSDs 58, 60, 62. However, the mobile computing device 70 can communicate directly with the PSDs 58, 60, 62 when the server is down or there is an emergency. The mobile computing device 70 runs a web browser that acts as a front end of the control and monitoring software 54 on the server 52. The server 52 is designed to be controlled through any machine that has a browser and the appropriate encryption software.

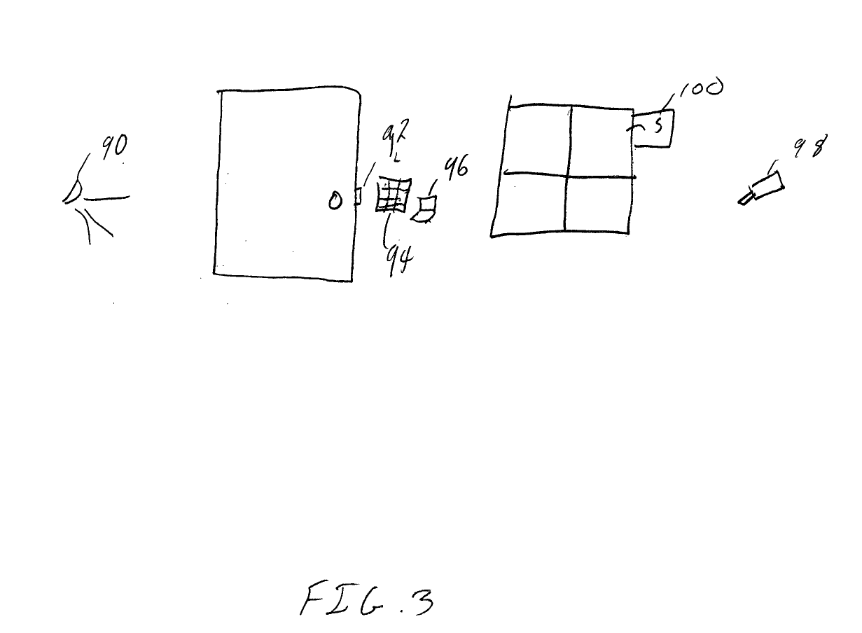

FIG. 3 is a graphical depiction of the physical security devices in accordance with one embodiment of the invention. The physical security devices include motion detectors 90, controllable doors 92, keypad access panels for doors 94, biometric readers 96, closed circuit cameras 98 and event sensors such as a window sensor 100. Any combination of these and other physical security devices may be used to protect a building from outside intruders, unauthorized access by employees or former employees and for fire detection.

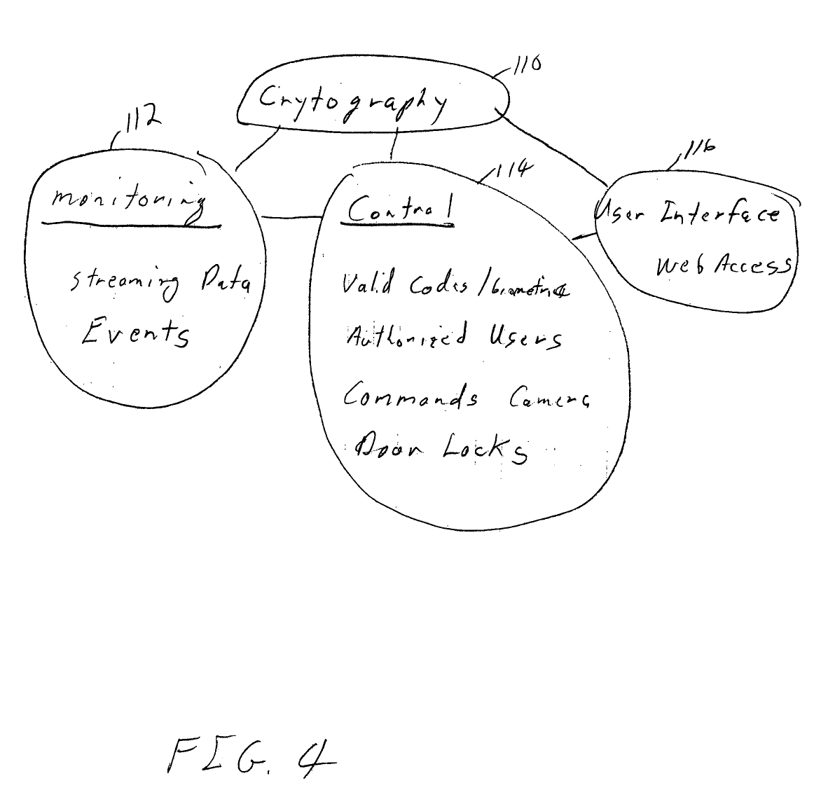

FIG. 4 is a block diagram of the software running on a server in accordance with one embodiment of the invention. A cryptography or encryption software 110 controls access to all the other software functions related to the security system. The cryptographic system 110 is in communication with the monitoring system 112. The monitoring module 112 logs events associated with each of the physical security devices. The log includes date, time, type of event and device. The monitoring module 112 may also log streaming data from a camera or other device. All events are logged for future analysis. The logging of events is used to determine unusual patterns of behavior by employees or contractors. The control module 114 manages the lists of valid codes for keypads and lists of valid biometrics. This is useful in denying access to former employees, employees that have been assigned to new projects and employees that have been demoted. This function is accessible from the mobile computing device so that there is minimal lag time between the change in an employee's status and their access to sensitive areas of the building. The control module 114 also includes a list of authorized users for various devices, commands cameras to pan/zoom or turn to a new view. The control module controls door locks. This allows the control module to lock all doors in case of an unauthorized access. Alternatively, it allows the system to unlock all the doors in the case of a fire. The server also has a user interface 116 that allows web access by remote users.

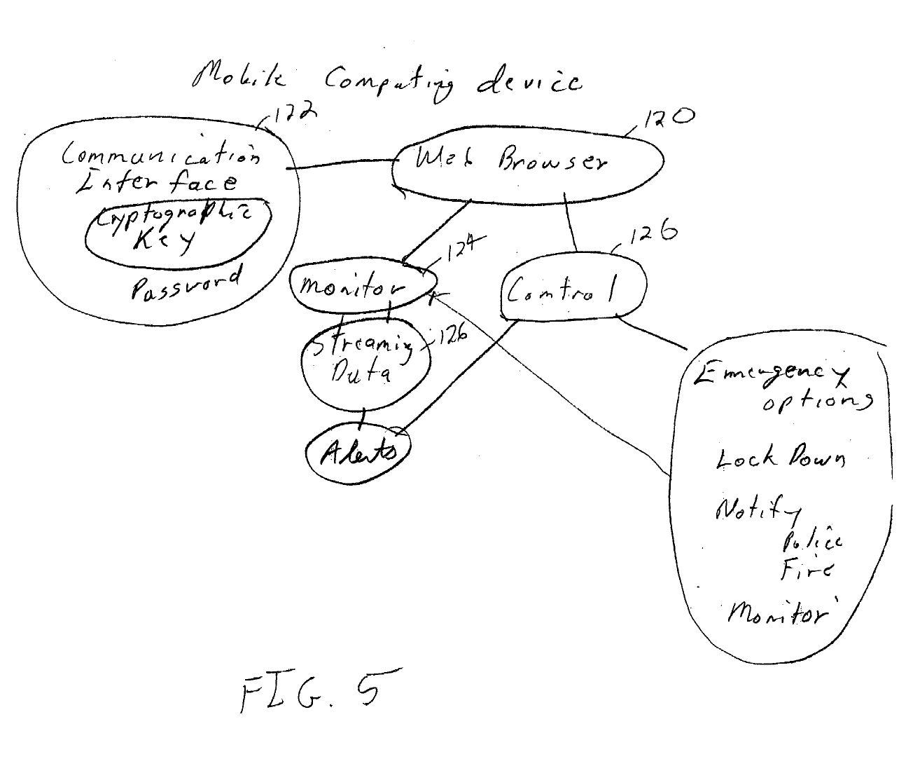

FIG. 5 is a block diagram of the software running on a mobile computing device in accordance with one embodiment of the invention. A web browser 120 is used to access most of the functions on the mobile computing device. The web browser 120 is coupled to a communication interface 122 for communication with external devices. The communication interface includes a cryptographic key and encryption system that is necessary, in some embodiments, to access the server or physical security devices. The communication interface 122 also includes a password access module, that requires the user to enter a password and/or provide a biometric parameter (fingerprint, handwriting recognition, etc) before the user is allowed access to the security system functions. The mobile computing device has a similar set of monitoring 124 and control 126 software modules. The monitoring module 124 is capable of receiving streaming data 128 from a camera or other physical security device. The monitoring module 124 may also receive alerts 128. For instance, the monitoring module 124 may receive an alert when an incorrect code is entered into a door keypad or when two incorrect key codes are entered consecutively. Alternatively, an alert may be received when the RFID reader data is inconsistent with the code entered into the door keypad. This may result in the control module 126 bring up a number of emergency options. These emergency options are preprogrammed into the mobile computing device. The emergency options may include a lock down feature where all the controllable locks are set to a lock condition. Another option may be to notify the police or the fire department. Alternatively, an alert may cause a camera's data to be streamed to the mobile computing device for evaluation.

The mobile computing device may also receive an alert when a certain set of doors are opened or remain open for a period of time or when a motion detector(s) detects a certain group of motions. The user may be notified of the alert by the mobile computing device having an audible alarm or a vibration. The control module 126 may also have a number preset functions, such as night operation, weekend operation, vacation operation or high security operation, fire detected operations, intruder operations, etc. The control module 126 can change the memory of the physical security device by removing a newly-fired employee from the list of authorized PIN numbers in a keypad door lock. The control module 126 will store the change in its memory and upload the information to the server. If the mobile computing device is accidentally destroyed before communicating with the server, then the server when next available will poll the physical security devices for changes. If it notes a change it will record the change and alert other users of the change. This allows the users to immediately know if an attacker has used a mobile computing device in emergency mode to change the memory of these devices. The password module can also require a smart card or other device be inserted into the mobile computing device to authenticate the user. In one embodiment, the mobile computing device can be controlled using voice recognition. The mobile computing device has the ability to implement macros to cause a series of actions to occur. An example is the lock down feature.

In one embodiment, the multiple WAP 76, 78, 80 may be used to triangulate (or use some other location algorithm) the location of mobile computing devices 70. In one embodiment, the RFID readers may also be used to determine the location of people or mobile computing devices. This information may be viewed by authorized personnel to locate all the devices or to determine the location of a mobile computing device that entered a bad password. In addition, the authorized personnel can locate employees nearest an alert event and communicate with them to investigate or take other action. Also by logging the location of the mobile computing devices and other events this information can be used to identify attackers on the security system.

Thus there has been described a remotely controllable security that does not require expensive security personnel or a central alarm monitoring station.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A remotely controllable security system comprising:
a plurality of physical security devices each having a wireless interface;
a server coupled to each of the plurality of physical security devices having a control and monitoring software that tracks events related to each of the plurality of physical security devices; and
a mobile computing device having a wireless interface and capable of communicating directly with each of the plurality of physical security devices, the mobile computing device having a cryptographic key necessary for communicating with the server.

2. The system of claim 1, wherein the plurality of physical security devices includes a keypad for a door and the server manages a list of authorized users.

3. The system of claim 1, wherein the plurality of physical security devices include a controllable door lock and the mobile computing device includes a lock down feature.

4. The system of claim 1, wherein the mobile computing device receives streaming data from one of the plurality of physical devices through the server.

5. The system of claim 1, wherein the mobile computing device includes a list of emergency responses.

6. The system of claim 5, wherein the list of emergency responses includes transmitting a message to at least one of the physical security devices to change its state.

7. The system of claim 1, wherein the mobile computing device has a security software module that has a password access feature.

8. A remotely controllable security system, comprising:
a plurality of physical security devices at least one of which has a wireless interface;
a control and monitoring software tracking events related to each of the plurality of physical security devices; and
a mobile computing device having a wireless interface, the mobile computing device having a quick list of emergency responses.

9. The system of claim 8, wherein the list of emergency responses includes a lock down feature.

10. The system of claim 9, wherein the lock down feature includes directly transmitting a message to one of the physical security devices to change its state.

11. The system of claim 10, wherein the mobile computing device has a cryptographic key necessary for communicating with the one of the physical security devices.

12. The system of claim 8, wherein the mobile computing device receives a streaming data from one of the plurality of physical devices through the server.

13. The system of claim 11, wherein the mobile computing device has a password access feature.

14. A remotely controllable security system comprising:
a plurality of physical devices;
a server coupled to the plurality of physical security devices;
a plurality of wireless access points; and
a mobile computing device that has a communication channel through one of the plurality of wireless access points to the server.

15. The system of claim 14, wherein the server has a locate mobile computing device function that uses a signal between a subset of the plurality of wireless access points and the mobile computing device to locate the mobile computing device.

16. The system of claim 14, wherein the mobile computing device receives an alert when an incorrect code is entered into one of the plurality of physical security devices.

17. The system of claim 14, wherein the mobile computing device has a list of emergency responses.

18. The system of claim 17, wherein the list of emergency responses includes a lock down feature.

19. The system of claim 18, wherein the lock down feature transmits a message to one of the plurality of physical devices to change its state.

20. The system of claim 14, wherein the mobile computing device has a cryptographic key necessary for communicating with the server.
